(19) United States
(12) Patent Application Publication
(10) Pub. No.: US 2026/0176509 A1
(43) Pub. Date: Jun. 25, 2026

(54) BIO-BASED TWO-COMPONENT POLYURETHANE ADHESIVE COMPOSITION AND PREPARATION METHOD THEREOF

(71) Applicant: Henkel AG & Co. KGaA, Düsseldorf (DE)

(72) Inventors: Nan Zhang, Shanghai (CN); Jing Yang, Shanghai (CN); Huajun Xu, Shanghai (CN); Zhennan Luo, Shanghai (CN)

(21) Appl. No.: 19/540,991

(22) Filed: Feb. 16, 2026

Related U.S. Application Data
(63) Continuation of application No. PCT/CN2023/113761, filed on Aug. 18, 2023.

(51) Int. Cl. C09J 175/04; C08G 18/10; C08G 18/12; C08G 18/32; C08G 18/76; C09J 175/08

(52) U.S. Cl. CPC C09J 175/04; C08G 18/10; C08G 18/12; C08G 18/3206; C08G 18/7671; C09J 175/08

(57) ABSTRACT

The present invention relates to a bio-based two-component polyurethane adhesive composition, wherein at least 40 wt. % of all the organic ingredients in the composition is bio-based material. The bio-based two-component polyurethane adhesive composition exhibits an excellent bonding to various non-treated metal substrates. The bio-based two-component polyurethane adhesive composition is developed for being used as a corner joint adhesive in door and windows.

### TECHNICAL FIELD

The present invention relates to a bio-based two-component polyurethane adhesive composition, wherein at least 40 wt. % of all the organic ingredients in the composition is bio-based material. The bio-based two-component polyurethane adhesive composition according to the present invention exhibits excellent bonding to various non-treated metal substrates.

### BACKGROUND OF THE INVENTION

In recent years, with the economy developing, systematic windows/doors with larger and thicker glass become more and more popular because of their aesthetics, and thermal and acoustic insulation advantages; and they require a much higher profile strength, especially a much higher corner joint strength. Thus, in order to reinforce mechanically locked corner joints, a corner joint adhesive exhibiting an excellent bonding to various non-treated metal substrates, especially 3003 Aluminum profile or cleat, 6063 Aluminum profile or cleat, 6060 Aluminum profile or cleat, and SS301 Stainless steel cleats, is desired, since no treatment such as polishing and degreasing could be done at manufacture site.

However, all the adhesives which are currently used as a corner joint adhesive cannot exhibit a good bonding to various non-treated metal substrate at the same time. In addition, as is known in the art, generally, one-component polyurethane adhesives in the prior art will foam and thus exhibit a lower adhesion strength; whereas two-component polyurethane adhesives in the prior art will not foam, and thus exhibit a higher adhesion strength, but it is still difficult for currently available two-component polyurethane adhesives to achieve extremely high bonding strengths on different substrates, such as bonding strengths >15 MPa on non-treated substrates. Therefore, it is desirable to obtain a two-component polyurethane adhesive composition which exhibits an excellent bonding to various non-treated metal substrates.

Moreover, conventional two-component polyurethane adhesives are petrochemical-based and thus utilizes energy-intense processes. However, conventional natural oil based two component polyurethane adhesives face challenges to bond metal substrates with high strength, and generally need to introduce fossil based raw materials so as to improve bonding performance. There is an increased desire to reduce carbon footprint and to produce environmentally friendly two-component polyurethane adhesives. Therefore, a high performance bio-based two-component polyurethane adhesive composition having a high bio-based content is desired.

In view of the above, it would be desirable to provide a bio-based two-component polyurethane adhesive composition which has a high bio-based content, and exhibits an excellent bonding to various non-treated metal substrates.

### SUMMARY OF THE INVENTION

The present invention provides a bio-based two-component polyurethane adhesive composition comprising:
a component (A) comprising:
(a1) from 20 to 40 wt. % of a natural oil based polyol, based on the total weight of the component (A),
(a2) from 0.75 to 7.5 wt. % of a liquid bio-based phenolic resin, based on the total weight of the component (A),
(a3) from 1 to 10 wt. % of a modified castor oil polyester and/or a trifunctional polyether and/or a multifunctional polyester polyol having a functionality ≥2, based on the total weight of the component (A), and
(a5) from 20 to 50 wt. % of an inorganic filler, based on the total weight of the component (A); and
a component (B) comprising:
(b2) from 5 to 20 wt. % of a multifunctional polyisocyanate having a functionality ≥2, based on the total weight of the component (B), and
(b3) from 20 to 50 wt. % of an inorganic filler, based on the total weight of the component (B), wherein at least 40 wt. %, preferably at least 45 wt. %, of all the organic ingredients in the composition is bio-based material, and
the composition further comprises from 2 to 25 wt. % of a rheology modifier in the component (A) and/or the component (B), based on the total weight of the composition.

The present invention also provides a method of preparing the bio-based two-component polyurethane adhesive composition according to the present invention, comprising the following steps:
(1) preparing the component (A), comprising: mixing all liquid ingredients therein, including the ingredients (a1), (a2) and (a3), and a chain extender, if any, to obtain a mixture; mixing the ingredient (a5) and a moisture scavenger, if any, into the mixture obtained from the above; then adding the ingredients (a4) and (a6), a rheology modifier and/or a pigment, if any, into the mixture and further mixing the resultant mixture; and removing bubbles therein; and
(2) preparing the component (B), comprising: mixing all liquid ingredients therein, including the ingredients (b1), (b2), and a plasticizer and/or a moisture scavenger, if any, to obtain a mixture; mixing the ingredient (b3) into the mixture obtained from the above; optionally, adding a rheology modifier and/or a pigment, if any, into the mixture and further mixing the resultant mixture; and removing bubbles therein.

The present invention further provides a method of corner joint bonding with the bio-based two-component polyurethane adhesive composition according to the present invention, comprising the following steps: mixing the component (A) and the component (B) in the composition to produce an uncured product; injecting the uncured product into the corner cavity; and allowing the uncured product to cure.

In addition, the present invention provides a cured product obtained from the bio-based two-component polyurethane adhesive composition according to the present invention.

Moreover, the present invention provides a use of the bio-based two-component polyurethane adhesive composition according to the present invention for bonding metals, marble, ceramic titles, woods, and surface treated plastics.

All of the bio-based two-component polyurethane adhesive composition, the preparing method, the bonding method, the cured product and the use according to the present invention are based on the following surprising discoveries of the inventors: the bio-based two-component polyurethane adhesive composition according to the present invention, which utilizes a specific combination of components (A) and (B), has a high bio-based content, and exhibits an excellent bonding to various non-treated metal substrates. In particular, the bio-based two-component polyurethane adhesive composition according to the present invention has a bio-based content ≥40%, and achieves a lap shear strength on Alu3003/Alu3003>15 MPa, a lap shear strength on Alu6063/Alu6063>18 MPa, and a lap shear strength on Alu6060/SS301>18 MPa.

### DETAILED DESCRIPTION OF THE INVENTION

It is to be understood by one of ordinary skill in the art that the present discussion is a description of exemplary embodiments only, and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, as used herein, the terms “a”, “an” and “the” include both singular and plural referents.

The terms “comprising” and “comprises” as used herein are synonymous with “including”, “includes”, “containing” or “contains”, and are inclusive or open-ended and do not exclude additional, non-recited members, elements or process steps.

Unless specified otherwise, the recitation of numerical end points includes all numbers and fractions subsumed within the respective ranges, as well as the recited end points.

Unless specified otherwise, all the term “room temperature” used herein refers to 23±2° C.

Unless specified otherwise, all the parameters used herein are measured according to the methods as stated in the working examples of the present description, if any.

Unless otherwise defined, all terms used in the disclosing the invention, including technical and scientific terms, have the meaning as commonly understood by one of the ordinary skill in the art to which this invention belongs.

According to the present invention, surprisingly, the inventors of the present invention found that a bio-based two-component polyurethane adhesive composition comprising: a component (A) comprising:
(a1) from 20 to 40 wt. % of a natural oil based polyol, based on the total weight of the component (A),
(a2) from 0.75 to 7.5 wt. % of a liquid bio-based phenolic resin, based on the total weight of the component (A),
(a3) from 1 to 10 wt. % of a modified castor oil polyester and/or a trifunctional polyether and/or a multifunctional polyester polyol having a functionality ≥2, based on the total weight of the component (A), and
(a5) from 20 to 50 wt. % of an inorganic filler, based on the total weight of the component (A); and
a component (B) comprising:
(b2) from 5 to 20 wt. % of a multifunctional polyisocyanate having a functionality ≥2, based on the total weight of the component (B), and
(b3) from 20 to 50 wt. % of an inorganic filler, based on the total weight of the component (B), wherein at least 40 wt. %, preferably at least 45 wt. %, of all the organic ingredients in the composition is bio-based material, and
the composition further comprises from 2 to 25 wt. % of a rheology modifier in the component (A) and/or the component (B), based on the total weight of the composition,
has a high bio-based content, and exhibits an excellent bonding to various non-treated metal substrates.

In a first aspect, the present disclosure is generally directed to a bio-based two-component polyurethane adhesive composition comprising:
a component (A) comprising:
(a1) from 20 to 40 wt. % of a natural oil based polyol, based on the total weight of the component (A),
(a2) from 0.75 to 7.5 wt. % of a liquid bio-based phenolic resin, based on the total weight of the component (A),
(a3) from 1 to 10 wt. % of a modified castor oil polyester and/or a trifunctional polyether, based on the total weight of the component (A), and
(a5) from 20 to 50 wt. % of an inorganic filler, based on the total weight of the component (A); and
a component (B) comprising:
(b2) from 5 to 20 wt. % of a multifunctional polyisocyanate having a functionality ≥2, based on the total weight of the component (B), and
(b3) from 20 to 50 wt. % of an inorganic filler, based on the total weight of the component (B), wherein at least 40 wt. %, preferably at least 45 wt. %, of all the organic ingredients in the composition is bio-based material, and
the composition further comprises from 2 to 25 wt. % of a rheology modifier in the component (A) and/or the component (B), based on the total weight of the composition.

### Ingredient (a1)

According to the present invention, the component (A) of the bio-based two-component polyurethane adhesive composition comprises (a1) from 20 to 40 wt. % of a natural oil based polyol, based on the total weight of the component (A).

Examples of the natural oil based polyol include, but are not limited to: a castor oil based polyol, a lesquerella oil based polyol, a soybean oil based polyol, a coconut oil based polyol, a cochin oil based polyol, a corn oil based polyol, a cottonseed oil based polyol, a linseed oil based polyol, an olive oil based polyol, a palm oil based polyol, a palm kernel oil based polyol, a peanut oil based polyol, a sunflower oil based polyol, a tall oil based polyol, a tallow based polyol, a tung oil based polyol, a whale oil based polyol, a tea seed oil based polyol, a sesame seed oil based polyol, a safflower oil based polyol, a rapeseed oil based polyol, a fish oil based polyol, any derivatives thereof, and any combinations thereof. Preferably, the natural oil based polyol used in the present invention is selected from the group consisting of a castor oil based polyol, a lesquerella oil based polyol, a soybean oil based polyol, a coconut oil based polyol, a cochin oil based polyol, a corn oil based polyol, a cottonseed oil based polyol, a linseed oil based polyol, an olive oil based polyol, a palm oil based polyol, a palm kernel oil based polyol, a peanut oil based polyol, a sunflower oil based polyol, a tall oil based polyol, a tallow based polyol, a tung oil based polyol, a whale oil based polyol, a tea seed oil based polyol, a sesame seed oil based polyol, a safflower oil based polyol, a rapeseed oil based polyol, a fish oil based polyol, any derivatives thereof, and any combinations thereof. More preferably, the natural oil based polyol used in the present invention is a castor oil based polyol.

Examples of commercially available natural oil based polyol include, but are not limited to: AGROL, including AGROL 3.0, a soy-based polyol, available from BioBased Technologies; SOYOL, including SOYOL R2-052, a soy-based polyol, available from Urethane Soy Systems Company; 1^{ST} grade castor oil, a 100% bio-based castor oil polyol, available from Panyu Zhongxin; and Polycin M-365, a 100% solids castor oil based derivative, available from Vertellus. Preferably, the natural oil based polyol is 1^{ST} grade castor oil, available from Panyu Zhongxin.

Preferably, the amount of ingredient (a1) is from 25 to 38 wt. %, based on the total weight of the component (A).

If the component (A) contains no ingredient (a1), the bio-based two-component polyurethane adhesive composition neither can achieve a bio-based content which is equal to or higher than 40%, nor can exhibit an excellent bonding to various non-treated metal substrates.

### Ingredient (a2)

According to the present invention, the component (A) of the bio-based two-component polyurethane adhesive composition comprises (a2) from 0.75 to 7.5 wt. % of a liquid bio-based phenolic resin, based on the total weight of the component (A).

Preferably, the liquid bio-based phenolic resin used in the present invention is a cashew nut shell oil based phenolic resin. Examples of commercially available liquid bio-based phenolic resin include, but are not limited to: Polycard XFN-50, Polycard XFN-53, and Polycard 425M, all of which are available from Chemical Technical Services Inc. of Kettering Ohio; CX-9201, CX 9203, NX-9001, NX-9001LV, NX-9004, NX-5285, GX-9005, GX-9006, GX-9007, GX-9101, GX-9102, GX-9103, and GX-9104, all of which are available from Cardolite Corp. of Monmouth Junction N.J.; and Agrol Platinum available from BioBased Technologies of Rogers Ark. Preferably, the liquid bio-based phenolic resin is NX-9001 available from Cardolite.

Preferably, the amount of ingredient (a2) is from 1 to 5 wt. %, and preferably from 2 to 4.5 wt. %, each based on the total weight of the component (A).

If the component (A) contains no ingredient (a2), or the amount of ingredient (a2) does not fall within the range of from 0.75 to 7.5 wt. %, based on the total weight of the component (A), the bio-based two-component polyurethane adhesive composition cannot exhibit an excellent bonding to various non-treated metal substrates.

### Ingredient (a3)

According to the present invention, the component (A) of the bio-based two-component polyurethane adhesive composition comprises (a3) from 1 to 10 wt. % of a modified castor oil polyester and/or a trifunctional polyether and/or a multifunctional polyester polyol having a functionality ≥2, based on the total weight of the component (A).

The modified castor oil polyester, trifunctional polyether and multifunctional polyester polyol having a functionality ≥2 used as ingredient (a3) may be those conventionally used in the art to which the present invention belongs.

Examples of commercially available modified castor oil polyester include, but are not limited to: Sovermol 760, available from BASF; LOCTITE LA 6099, available from Henkel; and Sovermol 805, available from BASF. Preferably, the modified castor oil polyester used herein is Sovermol 760, available from BASF; and/or LOCTITE LA 6099, available from Henkel.

Examples of commercially available trifunctional polyether include, but are not limited to: VORANOL CP 450, a trifunctional polypropylene glycol, available from Dow. Preferably, the trifunctional polyether used herein is VORANOL CP 450, available from Dow.

Although the component (A) of the bio-based two-component polyurethane adhesive composition according to the present invention may comprise a modified castor oil polyester and/or a trifunctional polyether and/or multifunctional polyester polyol having a functionality ≥2 as ingredient (a3), it is preferred that the component (A) merely comprises a modified castor oil polyester or a trifunctional polyether as ingredient (a3). In a preferable embodiment of the present invention, when the component (A) merely comprises a modified castor oil polyester as ingredient (a3), one or two modified castor oil polyesters may be used.

In a preferable embodiment of the present invention, when the component (A) of the bio-based two-component polyurethane adhesive composition merely comprises a modified castor oil polyester as ingredient (a3), the total amount of the modified castor oil polyester is from 2 to 10 wt. %, and preferably from 3 to 9 wt. %, each based on the total weight of the component (A). When the amount of the modified castor oil polyester is within the above preferable ranges, the bonding strength of the bio-based two-component polyurethane adhesive composition to various non-treated metal substrates are further improved.

In another preferable embodiment of the present invention, when the component (A) of the bio-based two-component polyurethane adhesive composition merely comprises a trifunctional polyether as ingredient (a3), the total amount of the trifunctional polyether is from 5 to 10 wt. %, and preferably from 6 to 9 wt. %, each based on the total weight of the component (A). When the amount of the trifunctional polyether is within the above preferable ranges, the bonding strength of the bio-based two-component polyurethane adhesive composition to various non-treated metal substrates are further improved.

### Ingredient (a4)

According to the present invention, the component (A) of the bio-based two-component polyurethane adhesive composition may optionally comprise (a4) a catalyst. Preferably, the component (A) of the bio-based two-component polyurethane adhesive composition according to the present invention comprises (a4) a catalyst. More preferably, the amount of the ingredient (a4) is from 0.003 to 0.1 wt. %, based on the total weight of the component (A).

The catalyst used as ingredient (a4) may be those conventionally used in the art to which the present invention belongs. The catalyst may be an aliphatic amine catalyst and/or an organometallic catalyst. Preferably, the catalyst is an organolead or organotin catalyst. More preferably, the catalyst is an organotin catalyst.

Examples of commercially available catalyst include, but are not limited to: Fomrez UL-28, an organotin catalyst, available from Momentive; and Fomrez UL-29, Dabco T 12, Dabco T 131, and Dabco 33LV, available from Evonik. Preferably, the catalyst used herein is Fomrez UL-28, available from Momentive.

### Ingredient (a5)

According to the present invention, the component (A) of the bio-based two-component polyurethane adhesive composition comprises (a5) from 20 to 50 wt. % of an inorganic filler, based on the total weight of the component (A).

The inorganic filler used as ingredient (a5) may be those conventionally used in the art to which the present invention belongs. Examples of the inorganic filler used as ingredient (a5) in the bio-based two-component polyurethane adhesive composition according to the present invention include, but are not limited to: heavy calcium carbonate, ultrafine silica powder, ceramic microbeads, aluminum oxide, aluminum hydroxide, talc, bentonite, attapulgite, calcium phosphate, calcium sulfate, magnesium oxide, zinc oxide, aluminum nitride and boron nitride, and any combinations thereof. Preferably, the inorganic filler used as ingredient (a5) herein is selected from the group consisting of heavy calcium carbonate, ultrafine silica powder and ceramic microbeads; more preferably, it is selected from the group consisting of heavy calcium carbonate and ultrafine silica powder; and most preferably, it is heavy calcium carbonate.

Examples of commercially available inorganic filler used as ingredient (a5) herein include, but are not limited to: Calcium Carbonate CC1000, a 1000 mesh heavy calcium carbonate, available from Guangfu Building Materials Fine Chemical Industry Co.; Calcium Carbonate CC700, a 700 mesh heavy calcium carbonate, available from Guangfu Building Materials Fine Chemical Industry Co; and SJF 0020, a 20 μm Ultrafine silica powder, available from SJF. Preferably, the inorganic filler used as ingredient (a5) is Calcium Carbonate CC1000 available from Guangfu Building Materials Fine Chemical Industry Co. and/or Calcium Carbonate CC700 available from Guangfu Building Materials Fine Chemical Industry Co.; and more preferably, it is Calcium Carbonate CC1000 available from Guangfu Building Materials Fine Chemical Industry Co.

Preferably, the amount of ingredient (a5) is from 20 to 45 wt. %, based on the total weight of the component (A).

### Ingredient (a6)

According to the present invention, the component (A) of the bio-based two-component polyurethane adhesive composition may optionally comprise (a6) from 0.1 to 1 wt. % of an adhesion promoter, based on the total weight of the component (A).

The adhesion promoter used as ingredient (a6) may be those conventionally used in the art to which the present invention belongs. Preferably, the adhesion promoter is a silane, and more preferably is a mercaptosilane.

Examples of commercially available adhesion promoter include, but are not limited to: Dynasylan MTMO, a silane adhesion promoter (3-mercaptopropyltritheoxysilane), available from Evonik. Preferably, the adhesion promoter is Dynasylan MTMO, available from Evonik.

Preferably, the component (A) of the bio-based two-component polyurethane adhesive composition comprises (a6) from 0.1 to 1 wt. % of an adhesion promoter, based on the total weight of the component (A). When the component (A) comprises ingredient (a6), the bonding strength of the bio-based two-component polyurethane adhesive composition to various non-treated metal substrates are further improved.

### Ingredient (a7)

In some embodiments of the present invention, the component (A) of the bio-based two-component polyurethane adhesive composition according to the present invention may further optionally comprise additives which are commonly used in the art to which the present invention belongs, such as a chain extender, a rheology modifier, a moisture scavenger, and a pigment, as long as they do not negatively affect the desired technical effects of the inventive composition. Preferably, the component (A) of the bio-based two-component polyurethane adhesive composition according to the present invention further comprises (a7) at least one ingredient selected from the group consisting of a chain extender, a rheology modifier, a moisture scavenger, and a pigment. The presence, the type and the amount of the additive can be determined by a specialist in the art according to requirements.

### Sedimentation Volume of Solid of the Component (A)

Moreover, surprisingly, the inventors of the present invention found that when the sedimentation volume of solid for the component (A) in the present invention is from 15 to 30 mL/g, and in particular from 20 to 25 mL/g, as measured by the method as stated in the working examples of the present invention, the bio-based two-component polyurethane adhesive composition according to the present invention is more suitable as a corner joint adhesive.

### Ingredient (b1)

According to the present invention, the component (B) of the bio-based two-component polyurethane adhesive composition may optionally comprise (b1) from 20 to 45 wt. % of a bio-based polyurethane prepolymer, based on the total weight of the component (B).

The bio-based polyurethane prepolymer used as ingredient (b1) may be those conventionally used in the art to which the present invention belongs. Preferably, the bio-based polyurethane prepolymer used as ingredient (b1) herein is obtained from a bio-based polyol and an isocyanate. More preferably, the bi-based polyol used for synthesizing ingredient (b1) is a 100% bio-based polyol; and/or the isocyanate used for synthesizing ingredient (b1) is selected from the group consisting of a liquefied diphenylmethane diisocyanate, 4,4′-diphenylmethane diisocyanate, 4,4′-diphenylmethane diisocyanate/2,4-diphenylmethane diisocyanate mixture, toluene diisocyanate, hexamethylene diisocyanate, isophorone diisocyanate, and their modified forms. Among others, carbodiimide modified MDI is further preferred as the isocyanate used for synthesizing ingredient (b1).

Examples of commercially available bio-based polyol used for synthesizing ingredient (b1) include, but are not limited to: 1^{ST} grade castor oil, a 100% bio-based castor oil polyol, available from Panyu Zhongxin; and Volvetol H1000, a 100% bio-based polyol, available from Weylchem. Preferably, the bio-based polyol used for synthesizing ingredient (b1) is 1^{ST} grade castor oil available from Panyu Zhongxin, and/or Volvetol H1000 available from Weylchem.

Examples of commercially available isocyanate used for synthesizing ingredient (b1) include, but are not limited to: Desmodur CD C, carbodiimide modified MDI (having a NCO content of 29%), available from Covestro AG. Preferably, the isocyanate used for synthesizing ingredient (b1) is Desmodur CD C, available from Covestro AG.

The reaction conditions of the preparation of bio-based polyurethane prepolymer used as ingredient (b1) can be determined by a person skilled in the art.

Preferably, the amount of the ingredient (b1) is from 30 to 45 wt. %, based on the total weight of the component (B).

Preferably, the ingredient (b1) has an isocyanate content of from 10 to 25 wt. %, based on the weight of the prepolymer.

### Ingredient (b2)

According to the present invention, the component (B) of the bio-based two-component polyurethane adhesive composition comprises (b2) from 5 to 20 wt. % of a multifunctional polyisocyanate having a functionality ≥2, based on the total weight of the component (B).

The multifunctional polyisocyanate having a functionality ≥2 used as ingredient (b2) may be those conventionally used in the art to which the present invention belongs. Preferably, the multifunctional polyisocyanate having a functionality ≥2 used as ingredient (b2) is a polymethylene polyphenyl polyisocyanate, and more preferably is 4,4′-diphenylmethanediisocyanate.

Examples of the multifunctional polyisocyanate having a functionality ≥2 used as ingredient (b2) include, but are not limited to: Desmodur 44V 20L, an isocyanate (4,4′-diphenylmethanediisocyanate), available from Covestro AG. Preferably, the multifunctional polyisocyanate having a functionality ≥2 used as ingredient (b2) is Desmodur 44V 20L available from Covestro AG.

### Ingredient (b3)

According to the present invention, the component (B) of the bio-based two-component polyurethane adhesive composition comprises (b3) from 20 to 50 wt. % of an inorganic filler, based on the total weight of the component (B).

The inorganic filler used as ingredient (b3) may be those conventionally used in the art to which the present invention belongs, and it may be the same as or different from the inorganic filler used as ingredient (a5). Examples of the inorganic filler used as ingredient (b3) in the bio-based two-component polyurethane adhesive composition according to the present invention include, but are not limited to: heavy calcium carbonate, ultrafine silica powder, ceramic microbeads, aluminum oxide, aluminum hydroxide, talc, bentonite, attapulgite, calcium phosphate, calcium sulfate, magnesium oxide, zinc oxide, aluminum nitride and boron nitride, and any combinations thereof. Preferably, the inorganic filler used as ingredient (b3) herein is selected from the group consisting of heavy calcium carbonate, ultrafine silica powder and ceramic microbeads; more preferably, it is selected from the group consisting of heavy calcium carbonate and ultrafine silica powder; and most preferably, it is heavy calcium carbonate.

Examples of commercially available inorganic filler used as ingredient (b3) herein include, but are not limited to: Calcium Carbonate CC1000, a 1000 mesh heavy calcium carbonate, available from Guangfu Building Materials Fine Chemical Industry Co.; Calcium Carbonate CC700, a 700 mesh heavy calcium carbonate, available from Guangfu Building Materials Fine Chemical Industry Co; and SJF 0020, a 20 μm Ultrafine silica powder, available from SJF. Preferably, the inorganic filler used as ingredient (b3) is Calcium Carbonate CC1000 available from Guangfu Building Materials Fine Chemical Industry Co. and/or Calcium Carbonate CC700 available from Guangfu Building Materials Fine Chemical Industry Co.; and more preferably, it is Calcium Carbonate CC1000 available from Guangfu Building Materials Fine Chemical Industry Co.

Preferably, the amount of ingredient (b3) is from 30 to 45 wt. %, based on the total weight of the component (B).

### Ingredient (b4)

In some embodiments of the present invention, the component (B) of the bio-based two-component polyurethane adhesive composition according to the present invention may further optionally comprise additives which are commonly used in the art to which the present invention belongs, such as a plasticizer, a moisture scavenger, a rheology modifier, and a pigment, as long as they do not negatively affect the desired technical effects of the inventive composition. Preferably, the component (B) of the bio-based two-component polyurethane adhesive composition according to the present invention further comprises (b4) at least one ingredient selected from the group consisting of a plasticizer, a moisture scavenger, a rheology modifier, and a pigment. The presence, the type and the amount of the additive can be determined by a specialist in the art according to requirements.

### Rheology Modifier

According to the present invention, the bio-based two-component polyurethane adhesive composition comprises from 2 to 25 wt. % of a rheology modifier in the component (A) and/or the component (B) as an essential ingredient, based on the total weight of the composition.

The rheology modifier used in the bio-based two-component polyurethane adhesive composition according to the invention may be those conventionally used in the in the art to which the present invention belongs. Examples of the rheology modifier include, but are not limited to: precipitated calcium carbonate, unmodified fumed silica and surface modified fumed silica. Preferably, the rheology modifier used herein is selected from the group consisting of precipitated calcium carbonate, unmodified fumed silica and surface modified fumed silica.

In addition, surprisingly, the inventors of the present invention found that when both of the ingredients (a5) and (b3) are heavy calcium carbonate, and the rheology modifier is a combination of precipitated calcium carbonate and fumed silica (covering both unmodified fumed silica and surface modified silica), the bonding strength of the bio-based two-component polyurethane adhesive composition to various non-treated metal substrates are further improved. That is to say, the specific combination of heavy calcium carbonate, precipitated calcium carbonate and fumed silica in the specific bio-based two-component polyurethane adhesive composition according to the invention brings about unexpected technical effects in terms of bonding strength to various non-treated metal substrates.

Preferably, the total amount of the rheology modifier is from 3 to 20 wt. %, and more preferably from 4 to 15 wt. %, each based on the total weight of the composition.

In a preferable embodiment of the present invention, the component (A) comprises from 2 to 25 wt. % of precipitated calcium carbonate and/or from 0 to 5 wt. % of fumed silica, based on the weight of the component (A).

Alternatively or additionally, in a preferable embodiment of the present invention, the component (B) comprises from 0 to 8 wt. % of precipitated calcium carbonate and/or from 1 to 5 wt. % of fumed silica, based on the weight of the component (B).

In a preferable embodiment of the present invention, the viscosities of the components (A) and (B) are similar to each other for better mixing. In particular, the ratio of the viscosity of component (A) to that of component (B) which is from 2:1 to 1:2 is preferred.

In another preferable embodiment of the present invention, both the thixotropic indexes of the components (A) and (B), which are calculated as the value of the low-shear viscosity at 1^{-s}/the high-shear viscosity at 10^{-s}, are >5, so as to ensure that a high viscosity at a low shearing rate and a low viscosity at a high shearing rate are obtained to obtain an excellent gap filling without sagging.

In a further preferable embodiment of the present invention, the component (A) comprises a pigment which shows a first color, the component (B) comprises a pigment which shows a second color, the mixture obtained by mixing the components (A) and (B) shows a third color, and the first color, the second color and the third color are different from each other, so as to provide visually detectable indications to ensure a correct mixing ratio when mixing. The bio-based two-component polyurethane adhesive composition according to this embodiment provides a visual foul proof indication during injection, and thus prevents the adhesive from leaking from cartridge due to high pressure when being used for corner-joint applications, which results in wrong mixing ration and low bonding strength after curing.

In a second aspect, the present disclosure is directed to a method of preparing the bio-based two-component polyurethane adhesive composition according to the present invention, comprising the following steps:
(1) preparing the component (A), comprising: mixing all liquid ingredients therein, including the ingredients (a1), (a2) and (a3), and a chain extender, if any, to obtain a mixture; mixing the ingredient (a5) and a moisture scavenger, if any, into the mixture obtained from the above; then adding the ingredient (a4), the ingredient (a6), a rheology modifier and/or a pigment, if any, into the mixture and further mixing the resultant mixture; and removing bubbles therein; and
(2) preparing the component (B), comprising: mixing all liquid ingredients therein, including the ingredients (b1) and (b2), and a plasticizer and/or a moisture scavenger, if any, to obtain a mixture; mixing the ingredient (b3) into the mixture obtained from the above; optionally, adding a rheology modifier and/or a pigment, if any, into the mixture and further mixing the resultant mixture; and removing bubbles therein.

The bio-based two-component polyurethane adhesive composition according to the present invention may be prepared by any conventional preparation method in the art. Preferably, the composition may be prepared by a method comprising the following steps: (1) preparing the component (A), comprising: mixing all liquid ingredients therein, including the ingredients (a1), (a2) and (a3), and a chain extender, if any, to obtain a mixture; mixing the ingredient (a5) and a moisture scavenger, if any, into the mixture obtained from the above; then adding the ingredients (a4) and (a6), a rheology modifier and/or a pigment, if any, into the mixture and further mixing the resultant mixture; and removing bubbles therein; and (2) preparing the component (B), comprising: mixing all liquid ingredients therein, including the ingredients (b1) and (b2), and a plasticizer and/or a moisture scavenger, if any, to obtain a mixture; mixing the ingredient (b3) into the mixture obtained from the above; optionally, adding a rheology modifier and/or a pigment, if any, into the mixture and further mixing the resultant mixture; and removing bubbles therein. The preparation of the composition is preferably carried out at room temperature. The mixer used in the preparation may be any conventional mixing device used in the art. After the preparation, the components (A) and (B) are separately packaged and stored before use.

In a third aspect, the present disclosure is directed to a method of corner joint bonding with the bio-based two-component polyurethane adhesive composition according to the present invention, comprising the following steps: mixing the component (A) and the component (B) in the composition to produce an uncured product, preferably by a static mixer; injecting the uncured product into the corner cavity; and allowing the uncured product to cure.

The component (A) and the component (B) are mixed at a volume ratio of the component (A) to the component (B) which is from 3:1 to 1:3, preferably 2:1 to 1:2, more preferably 1.5:1 to 1:1.5, and most preferably 1.1:1 to 1:1.1. In particular, the volume ratio of the component (A) to the component (B) is 1:1.

The uncured product of the bio-based two-component polyurethane adhesive composition according to the present invention may be cured by any conventional curing method in the art. Preferably, the uncured product may be cured at 20 to 100° C., preferably 20 to 90° C. for 1 hour to 48 hours, preferably 3 hours to 36 hours, more preferably 6 hours to 24 hours. More preferably, the uncured product may be cured under room temperature for 1 hour to 8 hours, and then be cured at 60 to 100° C. for 8 hours to 16 hours to accelerate the curing.

In a fourth aspect, the present disclosure is directed to a cured product obtained from the bio-based two-component polyurethane adhesive composition according to the present invention.

In a fifth aspect, the present disclosure is directed to a use of the bio-based two-component polyurethane adhesive composition according to the present invention for bonding metals, marble, ceramic titles, woods, and surface treated plastics.

The bio-based two-component polyurethane adhesive composition according to the present invention is preferably used for bonding metal substrates, especially untreated metal substrates, such as windows profile and corner-joint cleat. More specifically, the composition according to the present invention is used as a corner joint adhesive in doors and windows, especially in doors and windows made from aluminum and/or steel, such as in door and window frames.

The bio-based two-component polyurethane adhesive composition according to the present invention, which utilizes a specific combination of components (A) and (B), has a high bio-based content, and exhibits an excellent bonding to various non-treated metal substrates. In particular, the bio-based two-component polyurethane adhesive composition according to the present invention has a bio-based content ≥40%, and achieves a lap shear strength on Alu3003/Alu3003>15 MPa, a lap shear strength on Alu6063/Alu6063>18 MPa, and a lap shear strength on Alu6060/SS301>18 MPa.

### EXAMPLES

The following examples are intended to assist one skilled in the art to better understand and practice the present disclosure. The scope of the invention is not limited by the examples but is defined in the appended claims. All parts and percentages are based on weight unless otherwise stated.

Part I. Preparation of the Compositions and their Properties

### Raw Materials:

### Ingredient (a1):

Ingredient a1-1: 1^{ST} grade castor oil, a 100% bio-based castor oil polyol, available from Panyu Zhongxin.
Ingredient a1-2′: Poly BD R45V, a polyolefin resin (polybutanediol), available from Cray Valley.

### Ingredient (a2):

Ingredient a2-1: Cardolite NX-9001, a cashew nut shell oil based phenolic resin, available from Cardolite.

### Ingredient (a3):

Ingredient a3-1: VORANOL CP 450, a trifunctional polypropylene glycol, available from Dow.
Ingredient a3-2: Sovermol 760, a modified castor oil polyester, available from BASF.
Ingredient a3-3: LOCTITE LA 6099, a modified castor oil polyester, available from Henkel.
Ingredient a3-4: Sovermol 805, a modified castor oil polyester, available from BASF.

### Ingredient (a4):

Ingredient a4-1: Fomrez UL-28, a catalyst, available from Momentive.

### Ingredient (a5):

Ingredient a5-1: Calcium Carbonate CC1000, a 1000 mesh heavy calcium carbonate, available from Guangfu Building Materials Fine Chemical Industry Co.
Ingredient a5-2: Calcium Carbonate CC700, a 700 mesh heavy calcium carbonate, available from Guangfu Building Materials Fine Chemical Industry Co.
Ingredient a5-3: SJF 0020, a 20 μm Ultrafine silica powder, available from SJF.

### Ingredient (a6):

Ingredient a6-1: Dynasylan MTMO, a silane adhesion promoter (3-mercaptopropyltritheoxysilane), available from Evonik.

### Ingredient (a7):

Ingredient a7-1: Glycerol 99.7% USP, a chain extender, available from Cargill Incorporate.
Ingredient a7-2: Winnofil SPT, a rheology modifier (precipitated calcium carbonate), available from Imery.
Ingredient a7-3: Aerosil R 202, a rheology modifier (surface modified fumed silica), available from Evonik.
Ingredient a7-4: Aerosil 200, a rheology modifier (fumed silica), available from Evonik.
Ingredient a7-5: Purmol 3 ST, a moisture scavenger (3 Å Molecular sieve), available from ZEOCHEM AG.
Ingredient a7-6: Hostaperm Blue A4R, Pigment Blue 15:1, available from Clariant.

### Ingredient (b1):

Ingredient b1-1: 1^{ST} grade castor oil, a 100% bio-based castor oil polyol for preparing a bio-based polyurethane prepolymer, available from Panyu Zhongxin.
Ingredient b1-2: Volvetol H1000, a 100% bio-based polyol for preparing a bio-based polyurethane prepolymer, available from Weylchem.
Ingredient b1-3: Desmodur CD C, carbodiimide modified MDI (having a NCO content of 29%), available from Covestro AG.

### Ingredient (b2):

Ingredient b2-1: Desmodur 44V 20L, an isocyanate (4,4′-diphenylmethanediisocyanate), available from Covestro AG.

### Ingredient (b3):

Ingredient b3-1: Calcium Carbonate CC1000, a 1000 mesh heavy calcium carbonate, available from Guangfu Building Materials Fine Chemical Industry Co.
Ingredient b3-2: Calcium Carbonate CC700, a 700 mesh heavy calcium carbonate, available from Guangfu Building Materials Fine Chemical Industry Co.
Ingredient b3-3: SJF 0020, a 20 μm Ultrafine silica powder, available from SJF.

### Ingredient (b4):

Ingredient b4-1: Jayflex DINP, a plasticizer, available from Exxon Mobile.
Ingredient b4-2: Benzoflex 2088, a plasticizer, available from Eastman.
Ingredient b4-3: Additive TI, a moisture scavenger (Borchers tosyl isocyanate), available from Milliken.
Ingredient b4-4: Winnofil SPT, a rheology modifier (precipitated calcium carbonate), available from Imery.
Ingredient b4-5: Aerosil R 202, a rheology modifier (surface modified fumed silica), available from Evonik.
Ingredient b4-6: Yellow M2R 70, Pigment Yellow 139, available from Clariant.

### Preparation of Examples 1-8 (Ex.1 to Ex.8) and Comparative Examples 1 to 9 (CEx.1 to CEx.9)

Specific amounts and types of ingredients in the bio-based two-component polyurethane adhesive compositions of Examples 1 to 8 according to the present invention and Comparative Examples 1 to 9 are shown in Tables 1 to 4 as below. The compositions were prepared as follows:
preparing a bio-based polyurethane prepolymer (b1), comprising: charging the ingredients b-1 and b-2, if any, to a 750 mL reaction vessel; heating the mixture to 80° C. under 90 rpm stirring and 50 mbar vacuum to dehydrate the reaction mixture for 2 hours; charging the ingredient b-3 to the reaction vessel; and heating the mixture obtained from the above at 80° C. for 1 hour;
(1) preparing the component (A), comprising: mixing all liquid ingredients therein, including the ingredients (a1), (a2) and (a3), and the ingredient a7-1, if any, in a mixing cup at 1500 rpm by a speedmixer DAC 600 VAC-P for 2 minutes; charging the ingredient (a5) and the ingredient a7-5, if any, to the mixing cup, and mixing the resultant mixture at 1500 rpm by the speedmixer for 2 minutes; then charging the ingredients (a4) and (a6), and the ingredients a7-2, a7-3, a7-4 and a7-6, if any, to the mixing cup, and further mixing the resultant mixture at 1500 rpm under 100 mbar by the speedmixer for 5 minutes; and removing bubbles therein by centrifuging at 765 g for 3 minutes; and
(2) preparing the component (B), comprising: mixing all liquid ingredients therein, including the ingredients (b1) and (b2), and the ingredients b4-1, b4-2 and b4-3, if any, in a mixing cup at 1500 rpm by a speedmixer DAC 600 VAC-P for 2 minutes; charging the ingredient (b3) to the mixing cup and mixing the resultant mixture at 1500 rpm by the speedmixer for 2 minutes; charging the ingredients b4-4, b4-5 and b4-6, if any, to the mixing cup, and further mixing the resultant mixture at 1500 rpm under 100 mbar by the speedmixer for 5 minutes; and removing bubbles therein by centrifuging at 765 g for 3 minutes.

### Test Methods:

### As to Uncured Products of the Compositions:

The low-shear viscosity for each of the components (A) and (B) of the above compositions was measured by shearing the corresponding component at 25° C. and a spindle rotation rate of 1/sec using a MCR-302 rheometer available from Anton Paar with a CP-25-2 spindle for 3 minutes, and then reading the viscosity value, whose unit was Pa·s.

The high-shear viscosity for each of the components (A) and (B) of the above compositions was measured by shearing the corresponding component at 25° C. and a spindle rotation rate of 10/sec using a MCR-302 rheometer available from Anton Paar with a CP-25-2 spindle for 3 minutes, and then reading the viscosity value, whose unit was Pa·s.

The thixotropic index for each of the components (A) and (B) of the above compositions was calculated as the value of the low-shear viscosity/the high-shear viscosity of the corresponding component. In the present invention, for the bio-based two-component polyurethane adhesive composition, the thixotropic index for each of the components (A) and (B)>5 is desired.

Each of the components (A) and (B) of the above compositions was charged into a transparent vessel, and its color was visually observed; and then its appearance was visually observed after it was vibrated.

### As to Cured Products of the Compositions:

The components (A) and (B) for each of the above compositions were charged into a 1:1 two-component Mixpac 200 mL adhesive tube, and then were mixed with a MGQ Oct. 19, 1995 static mixer; and thereafter, the color of the resultant mixture was visually observed and then its appearance was visually observed after it was vibrated.

Lap shear strength on Alu3003/Alu3003, Lap shear strength on Alu6063/Alu6063, and Lap shear strength on Alu6060/SS301 of the cured product for each of the above compositions were tested according to Standard GB/T 7124-2008 as follows:

### Substrates Used:

Alu3003:3003 Aluminum plate having a dimension of 25 mm*100 mm*2 mm
Alu6063:6063 Aluminum plate having a dimension of 25 mm*100 mm*2 mm
Alu6060:6060 Aluminum plate having a dimension of 25 mm*100 mm*2 mm
SS301: SS301 Stainless steel plate having a dimension of 25 mm*100 mm*2 mm

All the above substrates were wiped with ethanol to remove dust and contaminate before use.

The components (A) and (B) for each of the above compositions were charged into a 1:1 two-component Mixpac 200 mL adhesive tube, and then were mixed with a MGQ Oct. 19, 1995 static mixer. The resultant mixture was coated on one end of one substrate, another substrate was placed on the mixture under pressure, and then the two substrates were fixed with a clip to obtain a specimen. The specimen was cured at room temperature for 4 hours, and then was placed in an oven at 80° C. for 12 hours to accelerate the curing; and after that, the specimen was removed from the oven.

Lap shear strength of the specimen was tested using a ZwickRoell universal tester with a pre-tensile force being set to 5N and a tensile speed of 5 mm/min, and it was recorded as the fracture strength when the specimen was stretched until it was broken.

In the present invention, for the bio-based two-component polyurethane adhesive composition, a lap shear strength on Alu3003/Alu3003>15 MPa, a lap shear strength on Alu6063/Alu6063>18 MPa, and a lap shear strength on Alu6060/SS301>18 MPa are desired.

The bio-based content for each of the compositions was calculated according to the following equation:

$$Bio \% = {\sum }_{i = 1}^{n} Bio {\%}_{Component n} * W {\%}_{component n} / {\sum }_{i = 1}^{n} W {\%}_{component n}$$

Bio %_{Component n}: bio-based content of the nth organic component
W %_{Component n}: mass percentage of the nth organic component in the composition

In the present invention, for the bio-based two-component polyurethane adhesive composition, a bio-based content ≥40% is desired.

All the above parameters of the above compositions were tested and calculated using the methods stated above respectively, and the results thereof are shown in Tables 1-4 as below.

TABLE 1

| Ingredients | | | | | | | |
|---|---|---|---|---|---|---|---|
| (weight in g) | | Ex. 1 | Ex. 2 | Ex. 3 | Ex. 4 | Ex. 5 | Ex. 6 |
| Component (A) | | | | | | | |
| (a1) | a1-1 | 27.995 | 35.495 | 35.495 | 35.495 | 35.495 | 35.995 |
| | a1-2′ | — | — | — | — | — | — |
| (a2) | a2-1 | 5.000 | 1.000 | 2.000 | 4.500 | 5.000 | 5.000 |
| (a3) | a3-1 | 8.000 | — | — | — | — | — |
| | a3-2 | — | 4.000 | 4.000 | 4.000 | 4.000 | 4.000 |
| | a3-3 | — | 4.000 | 3.000 | 0.500 | — | — |
| | a3-4 | — | — | — | — | — | — |
| (a4) | a4-1 | 0.005 | 0.005 | 0.005 | 0.005 | 0.005 | 0.005 |
| (a5) | a5-1 | 32.900 | 39.900 | 39.900 | 39.900 | 39.900 | 39.900 |
| | a5-2 | — | — | — | — | — | — |
| | a5-3 | — | — | — | — | — | — |
| (a6) | a6-1 | 0.500 | 0.500 | 0.500 | 0.500 | 0.500 | — |
| (a7) | a7-1 | 2.000 | 2.000 | 2.000 | 2.000 | 2.000 | 2.000 |
| | a7-2 | 16.000 | 5.000 | 5.000 | 5.000 | 5.000 | 5.000 |
| | a7-3 | — | 3.000 | 3.000 | 3.000 | 3.000 | 3.000 |
| | a7-4 | — | — | — | — | — | — |
| | a7-5 | 7.500 | 5.000 | 5.000 | 5.000 | 5.000 | 5.000 |
| | a7-6 | 0.1 | 0.1 | 0.1 | 0.1 | 0.1 | 0.1 |
| Component (B) | | | | | | | |
| (b1) | b1-1 | 10.000 | 10.000 | 10.000 | 10.000 | 10.000 | 10.000 |
| | b1-2 | — | 2.000 | 2.000 | 2.000 | 2.000 | 2.000 |
| | b1-3 | 32.000 | 30.000 | 30.000 | 30.000 | 30.000 | 30.000 |
| (b2) | b2-1 | 10.000 | 10.000 | 10.000 | 10.000 | 10.000 | 10.000 |
| (b3) | b3-1 | 37.000 | 40.900 | 40.900 | 40.900 | 40.900 | 40.900 |
| | b3-2 | — | — | — | — | — | — |
| | b3-3 | — | — | — | — | — | — |
| (b4) | b4-1 | — | 4.000 | 4.000 | 4.000 | 4.000 | 4.000 |
| | b4-2 | 3.000 | — | — | — | — | — |
| | b4-3 | 0.500 | 0.500 | 0.500 | 0.500 | 0.500 | 0.500 |
| | b4-4 | 5.000 | — | — | — | — | — |
| | b4-5 | 2.500 | 2.500 | 2.500 | 2.500 | 2.500 | 2.500 |
| | b4-6 | 0.1 | 0.1 | 0.1 | 0.1 | 0.1 | 0.1 |

Test results
Uncured product

| | | | | | | |
|---|---|---|---|---|---|---|
| Low-shear Viscosity of | 393 | 189 | 191 | 347 | 207 | 241 |
| component (A) | | | | | | |
| Pa · s@1-s | | | | | | |
| High-shear Viscosity of | 57.3 | 22.2 | 22.8 | 47.3 | 28.5 | 35.2 |
| component (A) | | | | | | |
| Pa · s@10-s | | | | | | |
| Thixotropic index of | 6.86 | 8.51 | 8.38 | 7.33 | 7.26 | 6.85 |
| component (A) | | | | | | |
| Color/Appearance of | Blue | Blue | Blue | Blue | Blue | Blue |
| component (A) | paste | paste | paste | paste | paste | paste |
| Low-shear Viscosity of | 519.00 | 285.00 | 285.00 | 285.00 | 285.00 | 285.00 |
| component (B) | | | | | | |
| Pa · s@1-s | | | | | | |
| High-shear Viscosity of | 68.90 | 51.50 | 51.50 | 51.50 | 51.50 | 51.50 |
| component (B) | | | | | | |
| Pa · s@10-s | | | | | | |
| Thixotropic index of | 7.53 | 5.53 | 5.53 | 5.53 | 5.53 | 5.53 |
| component (B) | | | | | | |
| Color/Appearance of | Yellow | Yellow | Yellow | Yellow | Yellow | Yellow |
| component (B) | paste | paste | paste | paste | paste | paste |

Cured product

| | | | | | | |
|---|---|---|---|---|---|---|
| Color/Appearance | Green | Green | Green | Green | Green | Green |
| | solid | solid | solid | solid | solid | solid |
| Lap Shear Strength on | 15.4 | 15.9 | 16.675 | 16.53 | 16.2 | 15.35 |
| Alu3003/Alu3003 | | | | | | |
| (in Mpa) | | | | | | |
| Lap Shear Strength on | 19.27 | 21.75 | 22.55 | 21.47 | 22.7 | 21.7 |
| Alu6063/Alu6063 | | | | | | |
| (in Mpa) | | | | | | |
| Lap Shear Strength on | 20.33 | 21.45 | 20.5 | 22.6 | 22.3 | 21.55 |
| Alu6060/SS301 | | | | | | |
| (in Mpa) | | | | | | |
| Calculated Bio-based | 45.17% | 53.98% | 54.37% | 55.39% | 55.53% | 55.75% |
| content | | | | | | |

Note:
all the symbols “—” herein indicate that the corresponding ingredient does not exist or the corresponding result was not tested.

TABLE 2

| | | |
|---|---|---|
| Ingredients | | |
| (weight in g) | Ex. 7 | Ex. 8 |

| Component (A) | | | | |
|---|---|---|---|---|
| | (a1) | a1-1 | 35.495 | 28.000 |
| | | a1-2′ | — | — |
| | (a2) | a2-1 | 4.500 | 4.995 |
| | (a3) | a3-1 | — | 8.000 |
| | | a3-2 | 4.000 | — |
| | | a3-3 | 0.500 | — |
| | | a3-4 | — | — |
| | (a4) | a4-1 | 0.005 | 0.050 |
| | (a5) | a5-1 | — | — |
| | | a5-2 | — | 26.000 |
| | | a5-3 | 39.900 | — |
| | (a6) | a6-1 | 0.500 | — |
| | (a7) | a7-1 | 2.000 | 2.000 |
| | | a7-2 | 5.000 | 23.000 |
| | | a7-3 | 3.000 | — |
| | | a7-4 | — | — |
| | | a7-5 | 5.000 | 8.000 |
| | | a7-6 | 0.1 | — |
| Component (B) | | | | |
| | (b1) | b1-1 | 10.000 | 10.000 |
| | | b1-2 | 2.000 | — |
| | | b1-3 | 30.000 | 32.000 |
| | (b2) | b2-1 | 10.000 | 10.000 |
| | (b3) | b3-1 | — | — |
| | | b3-2 | — | 42.000 |
| | | b3-3 | 40.900 | — |
| | (b4) | b4-1 | 4.000 | 2.000 |
| | | b4-2 | — | — |
| | | b4-3 | 0.500 | 0.500 |
| | | b4-4 | — | — |
| | | b4-5 | 2.500 | 3.000 |
| | | b4-6 | 0.1 | — |

Test results
Uncured product

| | | |
|---|---|---|
| Low-shear Viscosity of | 509 | — |
| component (A) | | |
| Pa · s@1−s | | |
| High-shear Viscosity of | 73.5 | — |
| component (A) | | |
| Pa · s@10−s | | |
| Thixotropic index of | 6.92 | — |
| component (A) | | |
| Color/Appearance of | Blue | White |
| component (A) | paste | paste |
| Low-shear Viscosity of | 511.00 | — |
| component (B) | | |
| Pa · s@1−s | | |
| High-shear Viscosity of | 85.70 | — |
| component (B) | | |
| Pa · s@10−s | | |
| Thixotropic index of | 5.96 | — |
| component (B) | | |
| Color/Appearance of | Yellow | Brownish |
| component (B) | paste | paste |

Cured product

| | | |
|---|---|---|
| Color/Appearance | Green | White |
| | solid | solid |
| Lap Shear Strength on | — | 15.7 |
| Alu3003/Alu3003 | | |
| (in Mpa) | | |
| Lap Shear Strength on | — | — |
| Alu6063/Alu6063 | | |
| (in Mpa) | | |
| Lap Shear Strength on | — | — |
| Alu6060/SS301 | | |
| (in Mpa) | | |
| Calculated Bio-based | 55.39% | — |
| content | | |

TABLE 3

| Ingredients | | | | | | |
|---|---|---|---|---|---|---|
| (weight in g) | | CEx. 1 | CEx. 2 | CEx. 3 | CEx. 4 | CEx. 5 |
| Component (A) | | | | | | |
| (a1) | a1-1 | 35.495 | 40.495 | — | — | 35.495 |
| | a1-2′ | — | — | 29.945 | 25.495 | — |
| (a2) | a2-1 | — | — | 4.500 | 9.000 | 0.500 |
| (a3) | a3-1 | — | — | — | — | — |
| | a3-2 | 4.000 | 4.000 | 4.000 | 4.000 | 4.000 |
| | a3-3 | 5.000 | — | 5.000 | 5.000 | 4.500 |
| | a3-4 | — | — | — | — | — |
| (a4) | a4-1 | 0.005 | 0.005 | 0.005 | 0.005 | 0.005 |
| (a5) | a5-1 | 39.900 | 39.900 | 39.900 | 39.900 | 39.900 |
| | a5-2 | — | — | — | — | — |
| | a5-3 | — | — | — | — | — |
| (a6) | a6-1 | 0.500 | 0.500 | 0.500 | 0.500 | 0.500 |
| (a7) | a7-1 | 2.000 | 2.000 | 3.000 | 3.000 | 2.000 |
| | a7-2 | 5.000 | 5.000 | 5.000 | 5.000 | 5.000 |
| | a7-3 | 3.000 | 3.000 | 3.000 | 3.000 | 3.000 |
| | a7-4 | — | — | — | — | — |
| | a7-5 | 5.000 | 5.000 | 5.000 | 5.000 | 5.000 |
| | a7-6 | 0.1 | 0.1 | 0.1 | 0.1 | 0.1 |
| Component (B) | | | | | | |
| (b1) | b1-1 | 10.000 | 10.000 | 10.000 | 10.000 | 10.000 |
| | b1-2 | 2.000 | 2.000 | 2.000 | 2.000 | 2.000 |
| | b1-3 | 30.000 | 30.000 | 30.000 | 30.000 | 30.000 |
| (b2) | b2-1 | 10.000 | 10.000 | 10.000 | 10.000 | 10.000 |
| (b3) | b3-1 | 40.900 | 40.900 | 40.900 | 40.900 | 40.900 |
| | b3-2 | — | — | — | — | — |
| | b3-3 | — | — | — | — | — |
| (b4) | b4-1 | 4.000 | 4.000 | 4.000 | 4.000 | 4.000 |
| | b4-2 | — | — | — | — | — |
| | b4-3 | 0.500 | 0.500 | 0.500 | 0.500 | 0.500 |
| | b4-4 | — | — | — | — | — |
| | b4-5 | 2.500 | 2.500 | 2.500 | 2.500 | 2.500 |
| | b4-6 | 0.1 | 0.1 | 0.1 | 0.1 | 0.1 |

Test results
Uncured product

| | | | | | |
|---|---|---|---|---|---|
| Low-shear Viscosity of | 297 | 222 | 456 | 365 | 352 |
| component (A) | | | | | |
| Pa · s@1-s | | | | | |
| High-shear Viscosity of | 35.3 | 30.77 | 102 | 86.1 | 50.2 |
| component (A) | | | | | |
| Pa · s@10-s | | | | | |
| Thixotropic index of | 8.41 | 7.21 | 4.47 | 4.23 | 7.04 |
| component (A) | | | | | |
| Color/Appearance of | Blue | Blue | Blue | Blue | Blue |
| component (A) | paste | paste | paste | paste | paste |
| Low-shear Viscosity of | 285.00 | 285.00 | 285.00 | 285.00 | 285.00 |
| component (B) | | | | | |
| Pa · s@1-s | | | | | |
| High-shear Viscosity of | 51.50 | 51.50 | 51.50 | 51.50 | 51.50 |
| component (B) | | | | | |
| Pa · s@10-s | | | | | |
| Thixotropic index of | 5.53 | 5.53 | 5.53 | 5.53 | 5.53 |
| component (B) | | | | | |
| Color/Appearance of | Yellow | Yellow | Yellow | Yellow | Yellow |
| component (B) | paste | paste | paste | paste | paste |

Cured product

| Color/Appearance | Green | Green | Green | Green | Green |
|---|---|---|---|---|---|
| | solid | solid | solid | solid | solid |
| Lap Shear Strength on | 14.7 | 14.5 | 7.08 | 7.53 | 14.87 |
| Alu3003/Alu3003 | | | | | |
| (in Mpa) | | | | | |
| Lap Shear Strength on | 23.45 | 22.45 | 5.52 (phase | 6.03 (phase | 21.11 |
| Alu6063/Alu6063 | | | separation) | separation) | |
| (in Mpa) | | | | | |
| Lap Shear Strength on | 21.8 | 21 | 7.69 | 7.37 | 21.51 |
| Alu6060/SS301 | | | | | |
| (in Mpa) | | | | | |
| Calculated Bio-based | 53.59% | 56.02% | 24.52% | 27.96% | 54.19% |
| content | | | | | |

TABLE 4

| Ingredients | | | | | |
|---|---|---|---|---|---|
| (weight in g) | | CEx. 6 | CEx. 7 | CEx. 8 | CEx. 9 |
| Component (A) | | | | | |
| (a1) | a1-1 | 30.495 | 20.495 | 18.000 | 28.000 |
| | a1-2′ | — | — | — | — |
| (a2) | a2-1 | 10.000 | 20.000 | — | 5.000 |
| (a3) | a3-1 | — | — | 8.000 | 8.000 |
| | a3-2 | 4.000 | 4.000 | — | — |
| | a3-3 | — | — | — | — |
| | a3-4 | — | — | 14.990 | — |
| (a4) | a4-1 | 0.005 | 0.005 | 0.010 | 0.010 |
| (a5) | a5-1 | 39.900 | 39.900 | — | — |
| | a5-2 | — | — | 45.500 | 46.000 |
| | a5-3 | — | — | — | — |
| (a6) | a6-1 | 0.500 | 0.500 | — | — |
| (a7) | a7-1 | 2.000 | 2.000 | 2.000 | 2.000 |
| | a7-2 | 5.000 | 5.000 | — | — |
| | a7-3 | 3.000 | 3.000 | — | — |
| | a7-4 | — | — | 3.000 | 3.000 |
| | a7-5 | 5.000 | 5.000 | 8.000 | 8.000 |
| | a7-6 | 0.1 | 0.1 | — | — |
| Component (B) | | | | | |
| (b1) | b1-1 | 10.000 | 10.000 | 10.000 | 10.000 |
| | b1-2 | 2.000 | 2.000 | — | — |
| | b1-3 | 30.000 | 30.000 | 32.000 | 32.000 |
| (b2) | b2-1 | 10.000 | 10.000 | 10.000 | 10.000 |
| (b3) | b3-1 | 40.900 | 40.900 | — | — |
| | b3-2 | — | — | 42.000 | 42.000 |
| | b3-3 | — | — | — | — |
| (b4) | b4-1 | 4.000 | 4.000 | 2.000 | 2.000 |
| | b4-2 | — | — | — | — |
| | b4-3 | 0.500 | 0.500 | 0.500 | 0.500 |
| | b4-4 | — | — | — | — |
| | b4-5 | 2.500 | 2.500 | 3.000 | 3.000 |
| | b4-6 | 0.1 | 0.1 | — | — |

Test results
Uncured product

| | | | | |
|---|---|---|---|---|
| Low-shear Viscosity of | 169 | 239 | — | — |
| component (A) | | | | |
| Pa · s@1−s | | | | |
| High-shear Viscosity of | 24.6 | 35.6 | — | — |
| component (A) | | | | |
| Pa · s@10−s | | | | |
| Thixotropic index of | 6.87 | 6.71 | — | — |
| component (A) | | | | |
| Color/Appearance of | Blue | Blue | White | White |
| component (A) | paste | paste | paste | paste |
| Low-shear Viscosity of | 285.00 | 285.00 | — | — |
| component (B) | | | | |
| Pa · s@1−s | | | | |
| High-shear Viscosity of | 51.50 | 51.50 | — | — |
| component (B) | | | | |
| Pa · s@10−s | | | | |
| Thixotropic index of | 5.53 | 5.53 | — | — |
| component (B) | | | | |
| Color/Appearance of | Yellow | Yellow | Brownish | Brownish |
| component (B) | pate | pate | paste | paste |

Cured product

| | | | | |
|---|---|---|---|---|
| Color/Appearance | Green | Green | White | White |
| | solid | solid | solid | solid |
| Lap Shear Strength on | 13.3 | 13.2 | 10.37 | 13.27 |
| Alu3003/Alu3003 | | | | |
| (in Mpa) | | | | |
| Lap Shear Strength on | 13.7 | 17 | — | — |
| Alu6063/Alu6063 | | | | |
| (in Mpa) | | | | |
| Lap Shear Strength on | 15.2 | 15.75 | — | — |
| Alu6060/SS301 | | | | |
| (in Mpa) | | | | |
| Calculated Bio-based | 55.05% | 54.08% | — | — |
| content | | | | |

From the data in Tables 1 & 2, it can be seen that the bio-based two-component polyurethane adhesive composition according to the present invention (Ex.1 to Ex.8), which utilizes a specific combination of components (A) and (B), has a high bio-based content, and exhibits an excellent bonding to various non-treated metal substrates. In particular, all these bio-based two-component polyurethane adhesive compositions of Ex.1 to Ex.8 had a bio-based content ≥40%, and achieved a lap shear strength on Alu3003/Alu3003>15 MPa, a lap shear strength on Alu6063/Alu6063>18 MPa, and a lap shear strength on Alu6060/SS301>18 MPa.

Moreover, by comparison, it can be seen that Ex.7 differs from Ex.4 merely in that the former contains ingredient (a5-3) instead of ingredient (a5-1), but all the viscosities of the components (A) and (B) of Ex.7 were much higher than those of Ex.4, and thus, Ex.7 was not more suitable as a corner joint adhesive than Ex.4. Thus, in the present invention, the inorganic filler (a5) is preferably a heavy calcium carbonate, as compared with ultrafine silica powder.

In contrast, from the data in Tables 3 & 4, it can be seen that the bio-based two-component polyurethane adhesive composition which are not according to the present invention (CEx.1 to CEx.9) either did not achieve a high bio-based content, or did not exhibit an excellent bonding to various non-treated metal substrates at the same time. For example, all of CEx.1, CEx.2 and CEx.8 (containing no ingredient (a2)) achieved a lap shear strength on Alu3003/Alu3003<15 Mpa. Both of CEx.3 and CEx.4 (containing a polyolefin resin instead of ingredient (a1)) achieved bio-based contents which were far lower than 40%, lap shear strengths on Alu3003/Alu3003 which were far lower than 15 MPa, lap shear strengths on Alu6063/Alu6063 which were far lower than 18 MPa, and lap shear strengths on Alu6060/SS301 which were far lower than 18 MPa. All of CEx.5, CEx.6 and CEx.7 (in which the contents of ingredient (a2) did not fall within the range of the present invention, and were 0.5 wt. %, 10 wt. % and 20 wt. %, respectively) achieved lap shear strengths on Alu3003/Alu3003 which were lower than 15 MPa; and both of CEx.6 and CEx.7 achieved lap shear strengths on Alu6063/Alu6063 which were lower than 18 MPa, and lap shear strengths on Alu6060/SS301 which were lower than 18 MPa.

Moreover, CEx.9 (in which both of the ingredients (a5) and (b3) are heavy calcium carbonate, and the rheology modifier is merely fumed silica) achieved lap shear strengths on Alu3003/Alu3003 which were lower than 15 MPa.

### Part II. Sedimentation Volume of Solid of the Component (A)

Specific amounts and types of ingredients in the components (A) of Examples 1, 9 and 10 according to the present invention are shown in Table 5 as below. The components (A) were prepared according to the general method in Part I.

The component (A) for each of Examples 1, 9 and 10 was placed into a glass bottle, 30 g ethanol was added into the glass bottle, and the resultant mixture was stirred and ultrasonically shaken for 30 minutes to completely dissolve the component (A) within ethanol. After that, the mixture was transferred to a 50 mL centrifuge tube, and then was centrifuged at an acceleration of 765 g for 10 minutes. Finally, the sedimentation volume of solid was read for comparison.

The sedimentation volumes of solid of the above components (A) were tested using the methods stated above, and the results thereof are shown in Table 5 as below.

TABLE 5

| | Ingredients | | | | |
|---|---|---|---|---|---|
| | (weight in g) | | Ex. 1 | Ex. 9 | Ex. 10 |
| Component (A) | | | | | |
| | (a1) | a1-1 | 27.995 | 35.495 | 35.495 |
| | | a1-2′ | — | — | — |
| | (a2) | a2-1 | 5.000 | 4.500 | 4.500 |
| | (a3) | a3-1 | 8.000 | — | — |
| | | a3-2 | — | 4.000 | 4.000 |
| | | a3-3 | — | 0.500 | 0.500 |
| | | a3-4 | — | — | — |
| | (a4) | a4-1 | 0.005 | 0.005 | 0.005 |
| | (a5) | a5-1 | 32.900 | 40.000 | — |
| | | a5-2 | — | — | — |
| | | a5-3 | — | — | 45.000 |
| | (a6) | a6-1 | 0.500 | 0.500 | 0.500 |
| | (a7) | a7-1 | 2.000 | 2.000 | 2.000 |
| | | a7-2 | 16.000 | 5.000 | — |
| | | a7-3 | — | 3.000 | 3.000 |
| | | a7-4 | — | — | — |
| | | a7-5 | 7.500 | 5.000 | 5.000 |
| | | a7-6 | 0.1 | — | — |

Performance

| | | | |
|---|---|---|---|
| Sedimentation volume of | 23 | 24 | 17.5 |
| solid (in mL/g) | | | |

From the data in Table 5, it can be seen that the sedimentation volume of solid for the component (A) in the present invention is preferably from 15 to 30 mL/g, and more preferably from 20 to 25 mL/g.

Although some preferred embodiments have been described, many modifications and variations may be made thereto in light of the above teachings. It is therefore to be understood that the invention may be practiced otherwise than as specifically described without departing from the scope of the appended claims.

1: A bio-based two-component polyurethane adhesive composition comprising:
a component (A) comprising:
(a1) from 20 to 40 wt. % of a natural oil based polyol, based on the total weight of the component (A),
(a2) from 0.75 to 7.5 wt. % of a liquid bio-based phenolic resin, based on the total weight of the component (A),
(a3) from 1 to 10 wt. % of a modified castor oil polyester and/or a trifunctional polyether and/or a multifunctional polyester polyol having a functionality ≥2, based on the total weight of the component (A), and
(a5) from 20 to 50 wt. % of a first inorganic filler, based on the total weight of the component (A); and
a component (B) comprising:
(b2) from 5 to 20 wt. % of a multifunctional polyisocyanate having a functionality ≥2, based on the total weight of the component (B), and
(b3) from 20 to 50 wt. % of a second inorganic filler, based on the total weight of the component (B),
wherein at least 45 wt. % of all the components, not including the first inorganic fillers and the second inorganic fillers, are bio-based material, and
the composition further comprises from 2 to 25 wt. % of a rheology modifier in the component (A) and/or the component (B), based on the total weight of the composition.

2: The bio-based two-component polyurethane adhesive composition according to claim 1, wherein the natural oil based polyol (a1) is selected from the group consisting of a castor oil based polyol, a lesquerella oil based polyol, a soybean oil based polyol, a coconut oil based polyol, a cochin oil based polyol, a corn oil based polyol, a cottonseed oil based polyol, a linseed oil based polyol, an olive oil based polyol, a palm oil based polyol, a palm kernel oil based polyol, a peanut oil based polyol, a sunflower oil based polyol, a tall oil based polyol, a tallow based polyol, a tung oil based polyol, a whale oil based polyol, a tea seed oil based polyol, a sesame seed oil based polyol, a safflower oil based polyol, a rapeseed oil based polyol, a fish oil based polyol, any derivatives thereof.

3: The bio-based two-component polyurethane adhesive composition according to claim 1, wherein the liquid bio-based phenolic resin (a2) is a cashew nut shell oil based phenolic resin.

4: The bio-based two-component polyurethane adhesive composition according to claim 1, wherein the amount of the liquid bio-based phenolic resin (a2) is from 2 to 4.5 wt. %, based on the total weight of the component (A).

5: The bio-based two-component polyurethane adhesive composition according to claim 1, wherein the component (A) further comprises 20 to 45 wt. %, based on the total weight of the component (B), of a (b1) bio-based polyurethane prepolymer obtained from a bio-based polyol and an isocyanate.

6: The bio-based two-component polyurethane adhesive composition according to claim 1, wherein the first inorganic filler (a5) and the second inorganic filler (b3) are heavy calcium carbonate, the rheology modifier is a combination of precipitated calcium carbonate and fumed silica.

7: The bio-based two-component polyurethane adhesive composition according to claim 1, wherein the component (A) further comprises (a6) from 0.1 to 1 wt. %, based on the total weight of the component (A), of an adhesion promoter, which is a mercaptosilane.

8: The bio-based two-component polyurethane adhesive composition according to claim 1, wherein the component (A) further comprises (a4) a catalyst and/or (a7) at least one ingredient selected from the group consisting of a chain extender, a rheology modifier, a moisture scavenger, and a pigment.

9: The bio-based two-component polyurethane adhesive composition according to claim 1, wherein the component (B) further comprises (b4) at least one ingredient selected from the group consisting of a plasticizer, a moisture scavenger, a rheology modifier, and a pigment.

10: The bio-based two-component polyurethane adhesive composition according to claim 1,
wherein the component (A) comprises a pigment having a first color, the component (B) comprises a pigment having a second color, the mixture obtained by mixing the components (A) and (B) having a third color, and
wherein the first color, the second color and the third color are different from each other.

11: The bio-based two-component polyurethane adhesive composition according to claim 1, wherein the volume ratio of the component (A) to the component (B) is from 1.1:1 to 1:1.1.

12: A method of preparing the bio-based two-component polyurethane adhesive composition according to claim 1, comprising the following steps:
(1) preparing the component (A) mixing (a1) the natural oil based polyol, (a2) the liquid bio-based polyol and (a3) the modified caster oil polyester and/or the trifunctional polyether and/or the multifunctional polyester poyol, to obtain a first mixture; adding (a5) the first inorganic filler into the first mixture; adding (a4) the catalyst and (a6) the adhesion promoter, optionally, a rheology modifier into the first mixture; and removing any bubbles from the first mixture; and
(2) preparing the component (B) mixing (b1) the bio-based polyurethan prepolymer and (b2) the multifunctional polyisocyanate, to obtain a second mixture; adding (b3) the second inorganic filer into the second mixture; optionally, adding a rheology modifier into the second mixture; and removing bubbles from the second mixture; and
(3) optionally packaging and storing the first mixture and the second mixture separately.

13: A method of bonding of a first substrate with a second substrate at a corner joint comprising:
(a) preparing the bio-based two-component polyurethane adhesive composition according to claim 12
(b) mixing the component (A) and the component (B) to produce an uncured;
(c) injecting the uncured adhesive into the cavity of the corner joint between the first substrate and the second substrate; and
(d) allowing the uncured product to cure at room temperature.

14: A cured adhesive obtained from the bio-based two-component polyurethane adhesive composition according to claim 1.

15: The method according to claim 13, wherein the first substrate and the second substrates, independently, are selected from the group consisting of metal, marble, ceramic title, wood, surface treated plastic.

16: An article comprising the cured adhesive of claim 14, which is a door corner joint or a window frame corner joint.
